(19) United States
(12) Patent Application Publication
(10) Pub. No.: US 2012/0051854 A1
(43) Pub. Date: Mar. 1, 2012

(54) SUPERHARD INSERT

(76) Inventor: Cornelius Johannes Pretorius, Shannon (IE)

(21) Appl. No.: 13/318,817

(22) PCT Filed: May 5, 2010
(86) PCT No.: PCT/EP2010/056120

§ 371 Date: Nov. 4, 2011

(30) Foreign Application Priority Data
May 6, 2009 (GB) 0907737.1

(51) Int. Cl. B23B 27/16; B23B 1/00; B23B 29/04

(52) U.S. Cl. 407/100; 407/115; 82/1.11

(57) ABSTRACT

A superhard insert for a machine tool, comprising a superhard cutter structure 20 defining a rake face 22, a flank 24 and a rounded cutting edge 26 formed by the transition between the rake face 22 and the flank 24; the flank 24 comprising a convex arcuate surface portion 28 extending away from the cutting edge 26, the arcuate surface portion 28 having a radius of curvature R2.

### FIELD

The invention relates to a superhard insert for a machine tool, particularly but not exclusively for machining a body comprising metal, more specifically for forming grooves into, parting, cutting or turning a body comprising titanium or a superalloy. The invention also relates to a tool comprising a superhard insert and a method for machining a body using such a tool.

### BACKGROUND

Cutting tools are used to form, bore or degrade workpieces or bodies by removing material from them. Examples of cutting tools are turning, milling or drilling tools, rock boring tools such as bits for oil and gas drilling, and attack tools such as picks used for pavement degradation and soft rock mining. Such tools typically comprise one or more cutting inserts typically comprising at least one cutting edge. Hard or abrasive workpiece materials, such as metal alloys, ceramics, cermets, certain composite materials and stone, need to be machined using tools having hard or super-hard cutting tips. Cemented tungsten carbide hard-metal is the most widely used tool material for machining hard workpiece materials, and is both hard and tough. Polycrystalline diamond (PCD) and polycrystalline cubic boron nitride (PCBN) are superhard materials, which are used for machining certain metal alloys widely used in the automotive industry, for example.

While superhard materials are extremely hard, they are generally less strong and tough than cemented carbide materials, and consequently they are more prone to fracture and chipping. Cemented carbide cutting tools may yield better tool life than PCD and PCBN tools due to their higher toughness and chip resistance, despite the fact that PCD and PCBN are vastly more resistant to abrasion. For example, standard texts indicate that carbide tools with negative rake angles should be used for the rough machining, or roughing, of titanium alloys when possible.

Japanese patent application number H6-28413 discloses an ultra-hard cutting tool comprising a layer of sintered diamond material having a surface that is arcuate in the horizontal (top) projection and defines a cutting edge.

Japanese patent application number S63-264300 discloses a diamond insert having a curved principal cutting edge, a trailing face and a flank face forming a curved surface between them.

U.S. Pat. No. 5,006,020 discloses a cutter insert for machining, especially a polygonal rotatable cutter insert with rounded cutter corners and a protective bevel configured as a double bevel running along the cutting tip, comprising: a body having a top surface and a corner radius and having a double bevel comprising a flat primary bevel, except in the corner radius.

PCT publication WO 2008/044991 discloses a negative insert for cutting machining having a top surface, a clearance face perpendicular thereto and a cutting tip in a region interconnecting these surfaces and extending substantially in parallel with these surfaces. The insert has a flat or rounded chamfer connecting the cutting tip to the clearance face on at least one lateral surface of the insert in the region of a corner thereof, and the chamfer makes an angle of 1 degree to 15 degrees with said clearance face for enabling application of said chamfer substantially tangentially to a work piece to be machined for bearing of the insert in two dimensions against said work piece during cutting machining operation carried out by the insert. It should be noted that the insert disclosed in WO2008/044991 may also include a convex wiper edge 14, as shown in FIG. 6 of the specification. The wiper edge should not be confused with the clearance face 10 or flank of the insert. More particularly, FIG. 6 is a top plan view of a cutting insert, whereas FIGS. 3 and 5 in the same specification are cross-sectional side views of cutting inserts.

There is a need to provide an insert for the rough cutting and grooving of difficult-to-machine metal alloys, particularly titanium alloys and heat-resistant super-alloys with enhanced tool life and increased productivity.

### SUMMARY

A first aspect of the invention provides a superhard insert for a machine tool, comprising a superhard cutter structure defining a rake face, a flank and a rounded cutting edge formed by the transition between the rake face and the flank; the flank comprising an arcuate surface portion extending away from the cutting edge, the arcuate surface portion having a radius of curvature. The arcuate surface portion is convex.

In one embodiment of the invention, the superhard cutter structure comprises polycrystalline diamond (PCD), and in one embodiment of the invention, the superhard structure comprises polycrystalline cubic boron nitride (PCBN).

In one embodiment of the invention, the superhard insert is for machining a metal body, such as a body comprising titanium, and in some embodiments the superhard insert is for grooving, cutting or turning a metal body.

In one embodiment of the invention, the radius of curvature of the arcuate surface portion of the flank is at least about 0.15 mm, at least about 1 mm or at least about 2 mm. In one embodiment of the invention, the radius of curvature of the arcuate surface portion of the flank is at most about 10 mm, at most about 8 mm, at most about 4 mm or at most about 2 mm. In one embodiment, the radius of curvature of the arcuate portion of the flank is about 1.2 mm.

In one embodiment of the invention, the rounded cutting edge has a radius of curvature extending between the rake face and the flank of at least about 0.01 mm, at least about 0.02 mm or at least about 0.04 mm. In one embodiment, the radius of curvature of the rounded cutting edge is less than about 0.15 mm, at most about 0.09 mm or at most about 0.07 mm.

In one embodiment of the invention, the rake face comprises an arcuate surface portion extending away from the cutting edge and having a radius of curvature of at least about 0.15 mm or at least about 1 mm. In one embodiment, the radius of curvature of the arcuate surface portion of the rake face is at most about 10 mm, at most about 8 mm, at most about 4 mm, or even at most about 2 mm.

In one embodiment of the invention, the superhard insert, the flank comprises a buttress surface defining an arc connecting the cutting edge with a clearance surface.

In one embodiment of the invention, the rake face comprises at least one rake land face and the clearance surface comprising at least one clearance land face, the enclosed angle between the at least one rake land face and at the at least one clearance land face being acute.

In some embodiments, the superhard structure comprises PCD comprising inter-bonded diamond grains having a mean grain size in terms of equivalent circle diameter (ECD) of at least about 0.5 microns and at most about 10 microns or at most about 5 microns.

A second aspect of the invention provides a tool comprising a superhard insert according to an aspect of the invention.

In one embodiment of the invention, the tool is for machining hard or difficult-to-machine materials, or a tool for boring into rock, such as a drill bit as may be used in the oil and gas drilling industry. In one embodiment, the tool is for forming grooves into, parting, rough machining or multidirectional turning of a body comprising titanium or a superalloy.

A third aspect of the invention provides a method for forming grooves into, parting, rough machining or multidirectional turning of a body comprising titanium or an alloy thereof, or a heat-resistant super-alloy, the method including engaging the body with a tool comprising a superhard insert according to an aspect of the invention with sufficient energy to remove material from the body.

In one embodiment, the method includes disposing the superhard insert in relation to the workpiece in a positive cutting geometry.

In one embodiment of the invention, the method include engaging a workpiece comprising a nickel-chromium-based superalloy (such as Inconel®) or hardened steel with a tool comprising an insert according to an aspect of the invention.

Embodiments of the invention have the advantage of resulting in substantial improvements in the productivity of machining bodies comprising hard-to-machine materials, particularly metal-containing materials, and more particularly bodies comprising titanium and certain superalloys. Embodiments of the invention have the advantage of enhanced tool life in aggressive or rough machining of such materials.

### DRAWING CAPTIONS

Non-limiting embodiments will now be describe with reference to the accompanying drawings, of which

FIG. 1 shows a schematic top view (horizontal projection) of an embodiment of a superhard machine tool.

FIG. 2 shows a schematic side view (lateral projection) of the embodiment of a superhard machine tool shown in FIG. 1.

FIG. 3 shows a schematic drawing of a partial side view (lateral projection) cross section X-Y of the embodiment of a superhard insert shown in FIG. 1 and FIG. 2.

FIG. 4 shows a schematic drawing of a partial side view (lateral projection) cross section through an embodiment of a superhard insert as in use removing material from a workpiece.

FIG. 5 shows a schematic partial cross sectional side view (lateral projection) of an embodiment of a superhard insert.

The same reference numbers refer to the same respective features in all drawings.

### DETAILED DESCRIPTION OF EMBODIMENTS

As used herein, a “rake face” or “rake surface” of a cutting tool is the surface or surfaces of the cutting tool over which the chips flow in use. As used herein, “chips” are the pieces of workpiece removed from the work surface by a machine tool in use. When the rake face is composed of a number of surfaces inclined to one another, these are designated first face, second face, and so forth, starting from the cutting edge.

As used herein, the “flank” is the tool surface or surfaces over which the surface produced on the workpiece by the cutting tool passes (i.e. the surface on the workpiece from which the chip material flowing over the rake face has been cut). When the flank face is composed of a number of surfaces inclined to one another, these are designated first flank, second flank, and so forth, starting from the cutting edge. A clearance surface is sometimes referred to in the art as a flank surface, and may also be composed of a first face, second face and so forth, starting from the cutting edge.

As used herein, the “cutting edge” is the edge of the rake face intended to perform cutting. A “rounded cutting edge” is a cutting edge that is formed by a rounded transition between the rake face and the flank.

As used herein, a “superhard material” is a material having a Vickers hardness of at least about 25 GPa. Polycrystalline diamond (PCD) material and polycrystalline cubic boron nitride (PCBN) material are examples of superhard materials. As used herein, PCD material comprises a mass of diamond grains, a substantial portion of which are directly inter-bonded with each other and in which the content of diamond is at least about 80 volume % of the material. In one embodiment of PCD material, interstices among the diamond gains may be at least partly filled with a binder material comprising a catalyst for diamond. As used herein, PCBN material comprises a mass of cBN grains dispersed within a wear resistant matrix, which may comprise ceramic or metal material, or both, and in which the content of cBN is at least about 50 volume % of the material. In some embodiments of PCBN material, the content of cBN grains is at least about 60 volume %, at least about 70 volume % or at least about 80 volume %. As used herein, a “polycrystalline superhard structure” means a structure comprising polycrystalline superhard material.

As used herein, a “machine tool” is a powered mechanical device, which may be used to manufacture components comprising materials such as metal, composite materials, wood or polymers by machining. As used herein, “machining” is the selective removal of material from a body, called a workpiece.

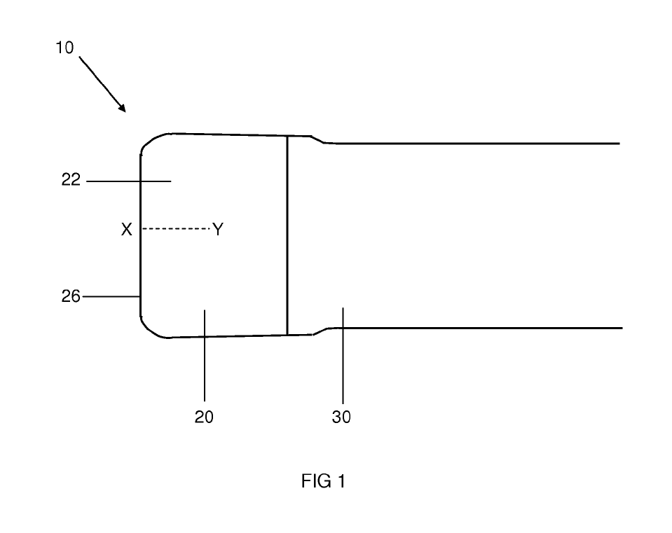

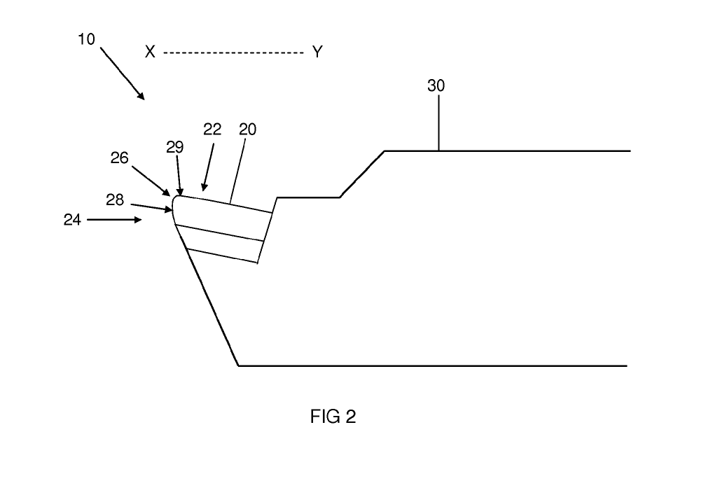

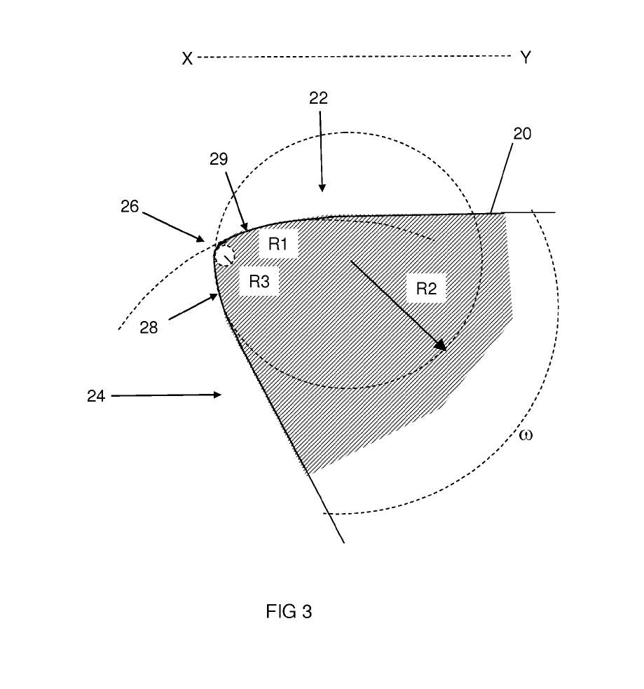

With reference to FIG. 1, FIG. 2 and FIG. 3, an embodiment of a superhard insert 10 for a machine tool (not shown) for machining grooves into a metal workpiece (not shown) comprises a polycrystalline diamond (PCD) structure 20 defining a rake face 22, a flank 24 and a rounded cutting edge 26 formed by the transition between the rake face 22 and the flank 24, the rounded cutting edge 26 having radius of curvature R3; the flank 24 comprising an arcuate surface portion 28 extending from the cutting edge 26 and having a radius of curvature R2 in a lateral projection. The arcuate surface portion 28 is generally convex when viewed in a lateral projection. The radius of curvature R2 of the arcuate surface portion 28 of the flank 24 is greater than the radius of curvature R3 of the rounded cutting edge 26, when viewed in a lateral projection. The rake face 22 also comprises a convex arcuate surface portion 29 extending from the rounded cutting edge 26 and having a radius of curvature R1 when viewed in a lateral projection. The arcuate surface portion 28 of the flank 24 may function as buttressing surface in use. The minimum angle, ω, enclosed between the rake face and the flank is at least about 66 degrees and less than 90 degrees.

As used herein, a rake angle is the inclination of a rake face relative to the workpiece surface, a positive rake angle permitting chips to move away from the workpiece and a negative rake angle directing chips towards the workpiece.

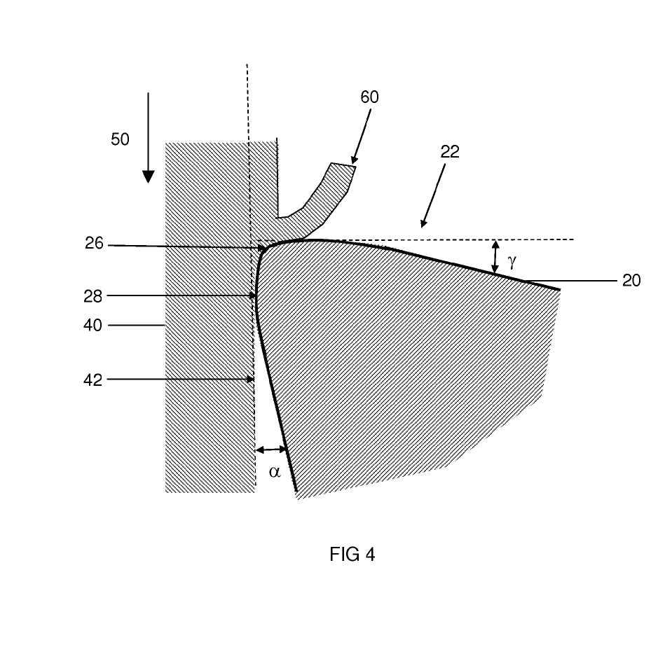

With reference to FIG. 4, the superhard cutting structure 20 of an embodiment of an insert (full insert not shown) is disposed in use relative to a workpiece 40 in a positive cutting geometry defined by a positive rake angle γ and a clearance angle α. The arcuate surface portion 28 of the flank, which may be referred to as buttressing surface, may abut the workpiece 40 rearward of the cutting edge 26 in relation to the rake face 22 and may project further slightly deeper into the body of the workpiece 40 than does the cutting edge 26. Cutting may be achieved by driving the cutting structure 20 against the workpiece 40 by, for example, causing it to rotate, or turn, in the direction 50 and cutting the workpiece 40, causing chips 60 to be removed by the cutting action. In one embodiment, α is in the range from 1 degree to 12 degrees, γ is in the range from 0 degrees to 12 degrees, R1 is less than or equal to 10 millimetres, R2 is less than 10 millimetres, R3 is less than 0.15 millimetres, and the angle co is between 66 degrees and 90 degrees.

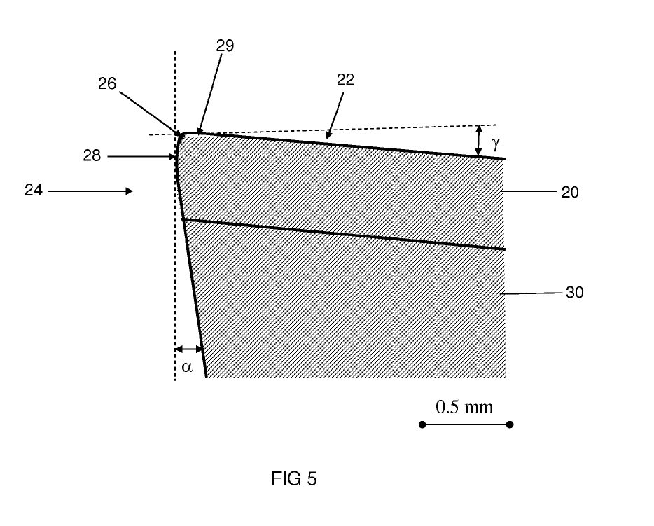

With reference to FIG. 5, an embodiment of a superhard insert 10 for a machine tool (not shown) comprises a superhard structure 20 in the form of a layer of PCD material bonded to a substrate 30 formed of cemented tungsten carbide. The PCD structure 20 is formed with a rounded cutting edge 26 at the transition between a rake face 22 and a flank 24, both the rake face 22 and the flank 24 comprising respective convex arcuate surface portions adjacent the cutting edge 26. The cutting structure 20 is shown disposed as in use in a positive cutting geometry, defined by a positive rake angle γ and a clearance angle α.

In use, the arcuate surface portion of the flank, or buttressing surface, may abut the workpiece behind the cutting edge and projects somewhat deeper into body of the workpiece than does the cutting edge. While wishing not to be bound by a particular theory, the interior region of the insert adjacent the arcuate surface portion of the flank, or buttressing surface, may provide increased mechanical support for the cutting edge in use, thereby functioning to strengthen it.

Variations of the shape of the cutting structure may be used and adapted depending on the characteristics of the workpiece, particularly the workpiece material, and machining conditions, such as speed, depth of cut, feed rate and so forth. For example, the flank or rake face, or both the flank and the rake face may comprise more than one arcuate portion, or may comprise a surface portion with a continuously varying radius of curvature. The structure and properties of the superhard structure may also be adapted. For example, in some embodiments the superhard structure may be formed of thermally stable PCD, which may comprise a region from which catalyst for diamond has been removed to enhance the properties of the PCD at elevated temperatures, or it may be formed of CVD diamond. At least a portion of the rake or clearance surface, or both, may be coated with a coating for protecting the cutting structure or enhancing the machining operation. Such a coating may comprise a material softer than that of the superhard structure, such as a carbide, nitride or boride.

“Roughing” is understood to be an aggressive form of machining in which workpiece material is removed at a relatively high rate by using a large depth of cut and feed rate. This is distinguished from “finishing”, where the objective being to produce a high tolerance finish, and so the depth of cut and feed rates are lower. In roughing operations, the load on the cutting edge of a tool is far greater than in finishing operations and so the cutting edge needs to be much stronger in a roughing operation, especially when the rake angle is positive. This makes hard or super-hard, but relatively brittle materials generally unsuitable for roughing certain difficult-to-machine workpiece materials, such as titanium alloys. For example PCD, PCBN or advanced ceramics are not typically used for the rough machining of difficult-to-machine materials, despite the high abrasion resistance of these materials.

Embodiments of the invention have the advantage that inserts comprising cutting structures formed of superhard material have extended working life in roughing or grooving of titanium-containing workpieces. While wishing not to be bound by a particular theory, the arcuate surface portion of the flank may function as a buttress, which may provide support for the cutting edge in use, thereby delaying, preventing or reducing fracture at the cutting edge.

As used herein, the equivalent circle diameter (ECD) of a particle is the diameter of a circle having the same area as a cross section through the particle. The ECD size distribution and mean size of a plurality of particles may be measured for individual, unbonded particles or for particles bonded together within a body, by means of image analysis of a cross-section through or a surface of the body.

Embodiments of the invention are described in more detail with reference to the examples below, which are not intended to limit the invention.

### Example 1

A polycrystalline diamond (PCD) compact was formed into an insert for a cutting tool. The PCD compact comprised a layer of PCD integrally bonded to cobalt-cemented tungsten carbide supporting substrate, the PCD comprising an inter-grown mass of diamond particles and cobalt dispersed within interstices between the diamond particles. The diamond particles had a mean size, in terms of equivalent circle diameter (ECD) in the range from about 0.5 micrometers to 2 micrometers and comprised at least 85% of the surface area of any polished surface of the PCD. The transverse rupture strength of the PCD was about 2,209 MPa, and its fracture toughness measured as K1C, as is well known in art, was about 13.4 MPa·m^{1/2}. The PCD had thermal conductivity of about 166 W·m⁻¹·K⁻¹. The PCD cutter insert was characterised by the following geometrical parameters:

R1=1.5 mm (radius of curvature of the arcuate surface of the rake face)
R2=1.2 mm (radius of curvature of the arcuate surface of the flank)
R3=0.02 mm (radius of curvature of the rounded cutting edge)
ω=66° (wedge angle)

The cutting tool was subjected to test in which it was used to perform a grooving operation on a workpiece formed of Ti-6Al-4V, using a Gildemeister ® CTX410 machine tool. The cutting speed was 80 m/min, the feed rate was 0.2-0.3 mm/rev, the depth of cut was 3 mm and the jet pressure was 150 bars. The “end of life” criteria for the cutter were signs of chipping, fracture or plastic deformation, or a “Vbmax” wear scar length of 0.6 mm. For comparison, a carbide tool used commercially for this kind of application, as well as a PCD cutter of a known design were also subjected to the test. The tool life of the PCD cutting tool of the example exceeded 40 minutes, compared to about 9 minutes for the carbide tool and about 3 minutes for the known PCD tool. The known PCD tool quickly failed as a result of fracture.

### Example 2

A PCD cutter insert was made as described in Example 1, except that the PCD cutter insert was characterised by the following geometrical parameters:

R1=9 mm (radius of curvature of the arcuate surface of the rake face)
R2=5 mm (radius of curvature of the arcuate surface of the flank)
R3=0.05 mm (radius of curvature of the rounded cutting edge)
ω=66° (wedge angle)

1. A superhard insert for a machine tool, comprising a superhard cutter structure defining a rake face, a flank and a rounded cutting edge formed by the transition between the rake face and the flank; the flank comprising a convex arcuate surface portion extending away from the cutting edge, the arcuate surface portion having a radius of curvature.

2. (canceled)

3. A superhard insert as claimed in claim 1, in which the radius of curvature of the arcuate surface portion of the flank is at least 0.15 mm and at most 10 mm.

4. A superhard insert as claimed in claim 2, in which the rounded cutting edge has a radius of curvature extending between the rake face and the flank of at least 0.01 mm and less than 0.15 mm.

5. A superhard insert as claimed in claim 3, in which the rake face comprises an arcuate surface portion extending away from the cutting edge and having a radius of curvature of at least 0.15 mm and at most 10 mm.

6. A superhard insert as claimed in claim 1, in which the rake face comprises at least one rake land face and the clearance surface comprising at least one clearance land face, the enclosed angle between the at least one rake land face and at the at least one clearance land face being acute.

7. A tool comprising a superhard insert as claimed in claim 1.

8. A tool as claimed in claim 7 for forming grooves into, parting, rough machining or multidirectional turning of a body comprising titanium or a superalloy.

9. A method for forming grooves into or rough machining a body comprising titanium or an alloy thereof, or a heat-resistant super-alloy, the method including engaging the body with a tool comprising a superhard insert as claimed in claim 1 with sufficient energy to remove material from the body.

10. A method as claimed in claim 9, the method including disposing the superhard insert in relation to the workpiece in a positive cutting geometry.

11. A superhard insert as claimed in claim 1, in which the rounded cutting edge has a radius of curvature extending between the rake face and the flank of at least 0.01 mm and less than 0.15 mm.

12. A superhard insert as claimed in claim 5, in which the rake face comprises an arcuate surface portion extending away from the cutting edge and having a radius of curvature of at least 0.15 mm and at most 10 mm.

13. A superhard insert as claimed in claim 1, in which the rake face comprises an arcuate surface portion extending away from the cutting edge and having a radius of curvature of at least 0.15 mm and at most 10 mm.

14. A superhard insert as claimed in claim 12, in which the radius of curvature of the arcuate surface portion of the flank is at least 0.15 mm and at most 10 mm.

15. A superhard insert as claimed in claim 1 in which the superhard cutter structure comprises polycrystalline diamond (PCD).
